(19) United States
(12) Patent Application Publication
(10) Pub. No.: US 2012/0062348 A1
(43) Pub. Date: Mar. 15, 2012

(54) LAMINATED COIL

(75) Inventor: Hiroki HASHIMOTO, Kyoto-fu (JP)

(73) Assignee: MURATA MANUFACTURING CO., LTD., Kyoto-fu (JP)

(21) Appl. No.: 13/217,063

(22) Filed: Aug. 24, 2011

(30) Foreign Application Priority Data
Sep. 15, 2010 (JP) 2010-206326

(51) Int. Cl. H01F 27/29

(52) U.S. Cl. 336/192

(57) ABSTRACT

A laminated coil includes a laminate having substantially rectangular insulating layers and coil patterns that are alternately laminated and unified, through holes, a coil formed inside the laminate from the coil patterns connected to each other via the through holes, external electrodes, and an insulating film formed on the outer peripheral surface of the laminate. At least one of the through holes is partially exposed in the surface of the laminate and is formed in contact with one side of the outer edge of the insulating layer but out of contact with the other sides other than the one side.

### CROSS REFERENCE TO RELATED APPLICATIONS

The present application claims priority to Japanese Patent Application No. 2010-206326 filed Sep. 15, 2010, the entire content of the application is being incorporated herein by reference in its entirety.

### BACKGROUND OF THE INVENTION

1. Field of the Invention

The present invention relates to a laminated coil, and more specifically to a laminated coil in which the diameters of coil patterns are increased and an insulating film is formed on the outer peripheral surface of a laminate.

2. Description of the Related Art

In recent years, in the electrical and electronic fields, many laminated coils having small sizes and being cost-effective and simple to mass produce have been used. In such a laminated coil, a plurality of insulating layers and a plurality of coil patterns are laminated in a desired order and unified, and the coil patterns are sequentially connected to each other via through holes, whereby a coil is formed within the laminate. In general, the coil patterns are formed with gaps inward of the outer edges of the insulating layers such that the outer edges of the coil patterns are not exposed in the outer peripheral surface of the laminate. It should be noted that for the insulating layers, a magnetic material or a nonmagnetic material is used.

It is known that in such a laminated coil, when the coil patterns are increased in size, the coil characteristics can be improved.

For example, in a magnetic-core type laminated coil including insulating layers made of a magnetic material, when the inner and outer diameters of coil patterns are increased while the widths of the coil patterns are kept the same, the direct current superposition characteristics of the coil can be improved.

Further, in an air-core type laminated coil including insulating layers made of a nonmagnetic material, when the inner and outer diameters of coil patterns are increased while the widths of the coil patterns are kept the same, the Q value of the coil can be increased.

Further, in each of the magnetic-core type and air-core type laminated coils, when the widths of the coil patterns are increased (i.e., the outer diameters are increased) while the inner diameters of the coil patterns are kept the same, the direct current resistances of the coil patterns can be decreased and the Q value of the coil can be increased.

However, in the laminated coil, when the coil patterns are increased in size, the entire shape of the laminate is increased in size.

Therefore, Japanese Unexamined Patent Application Publication No. 2000-133521 proposes, as a coil that solves the above-mentioned problem, a laminated coil in which coil patterns are increased in size but gaps between the outer edges of the coil patterns and the outer edges of insulating layers are minimized to zero to avoid an increase of the size of the entire shape of a laminate. Subsequently, the problem that the coil patterns are exposed in the outer peripheral surface of the laminate is solved by forming an insulating film made of an insulating resin on the peripheral surface of the laminate.

FIGS. 5 to 8 show a laminated coil 400 disclosed in Japanese Unexamined Patent Application Publication No. 2000-133521. FIG. 5 is a perspective view, FIG. 6 is a cross-sectional view of a portion along a broken line X-X in FIG. 5, FIG. 7 is a cross-sectional view of a portion along a broken line Y-Y in FIG. 5, and FIG. 8 is an exploded perspective view. In FIG. 8, external electrodes and an insulating film are omitted.

As shown in FIGS. 5 to 8, in the laminated coil 400, substantially rectangular insulating layers 101 made of a magnetic material or a nonmagnetic material and having four corners C, and coil patterns 102 are laminated in a desired order and unified to form a laminate 103. The coil patterns 102 are formed with large diameters, and their outer edges are in contact with the outer edges of the insulating layers 101 along an entire periphery of the coil patterns. In other words, gaps between the outer edges of the coil patterns 102 and the outer edges of the insulating layers 101 are zero. The coil patterns 102 are connected to each other through via holes 104a, each of which is provided at one corner C of the insulating layer 101 and formed to extend through the insulating layer 101, thereby forming a coil 105 within the laminate 103. It should be noted that near both ends of the laminate 103, no coil patterns 102 are laminated, and a plurality of insulating layers 101 having through holes 104b for drawing the coil 105 to the outside are laminated.

At the both ends of the laminate 103, a pair of external electrodes 106a and 106b are formed. The external electrode 106a is connected to one end of the coil 105, and the external electrode 106b is connected to the other end of the coil 105. In addition, on the outer peripheral surface of the laminate 103, an insulating film 107 made of an insulating resin is formed. The insulating film 107 is provided for insulating the outer edges of the coil patterns 102 and the through holes 104a, which are exposed in the outer peripheral surface of the laminate 103, from the outside.

In the laminated coil 400 having such a structure, when the insulating layers 101 are formed from a magnetic material, the coil becomes a magnetic-core type, but becomes an open magnetic circuit type coil since the outer edges of the coil patterns 102 reach the outer peripheral surface of the laminate 103. Therefore, magnetic saturation is unlikely to occur, a decrease of the inductance when a direct current flows is suppressed, and the direct current superposition characteristics are improved.

The existing laminated coil 400 is manufactured, for example, by the following method.

In order to manufacture a large number of laminated coils 400 in batch, a plurality of mother green sheets (not shown) from which insulating layers 101 are formed are prepared. Then, in each mother green sheet, through holes 104a or 104b for a plurality of laminated coils 400 are formed, and coil patterns 102 are formed. The through holes 104a and 104b are formed, for example, by embedding a conductive paste in holes that are previously formed in the mother green sheet. The coil patterns 102 are formed, for example, by screen-printing a conductive paste on a surface of the mother green sheet into a predetermined shape.

Next, the mother green sheets in which the predetermined through holes 104a and 104b and coil patterns 102 are formed are laminated in a predetermined order and compressed to form a laminate block (not shown).

Next, the laminate block is cut into a plurality of unfired laminates 103.

Next, the plurality of unfired laminates 103 are fired at a predetermined profile to obtain a plurality of laminates 103.

Next, external electrodes 106a and 106b are formed on both end surfaces of each laminate 103, and an insulating film 107 is formed on the outer peripheral surface of each laminate 103, to complete the laminated coil 400. The external electrodes 106a and 106b are formed, for example, by immersing the ends of each laminate 103 in a conductive paste to apply the conductive paste thereto, and performing baking. The insulating film 107 is formed, for example, by applying a thermoplastic epoxy resin by means of immersion (dipping) or printing, and heating the resin to cure the resin. On the external electrodes 106a and 106b, outer layers may be formed by means of plating.

Since the existing laminated coil 400 described above has the structure described above, the coil patterns can be increased in size without increasing the entire shape in size, to improve the coil characteristics.

However, the existing laminated coil 400 has the following problem. Specifically, in the laminated coil 400, the insulating film 107 is formed on the outer peripheral surface of the laminate 103, and, as shown in FIG. 7, the through holes 104a each provided at one of the four corners C of the insulating layer 101 are not fully coated with the insulating film 107 and thus are exposed to the outside.

Then, the reason why the through holes 104a are exposed to the outside is explained as follows.

First, as described above, the insulating layers 101 and the through holes 104a are fired and formed concurrently, and, in general, green sheets made of a ceramic or the like that are to be the insulating layers 101 have higher contraction ratios at firing than the conductive paste that is to be the through holes 104a. In other words, the green sheets that are to be the insulating layers 101 greatly contract, and thus the through holes 104a are formed so as to project from the insulating layers 101.

Then, at the corners C of the insulating layers 101 where the through holes 104a are formed, the insulating film 107 is unlikely to be attached to the laminate 103, and thus the thickness of the insulating film 107 becomes diminished at each corner C. In other words, the insulating film 107 is formed by a method of applying, heating, and curing an epoxy resin, or the like as described above, and the applied epoxy resin moves toward the center portion of the outer peripheral surface of the laminate 103, namely, toward the center portion of each side of the insulating layers 101 and thus is insufficient at the ridge portions of the laminate 103, namely, at the corners C of the insulating layers 101. As a result, the thickness of the insulating film 107 becomes diminished to a minimum at the corners C of the insulating layers 101.

In other words, due to the difference in contraction ratio, the through holes 104 are formed so as to project from the insulating layers 101. In addition, since the through holes 104a are formed at the corners C of the insulating layers 101 where the thickness of the insulating film 107 becomes diminished to a minimum, the through holes 104a are exposed from the insulating film 107 to the outside.

Then, when the through holes 104a are exposed from the insulating film 107 to the outside, the laminated coil 400 becomes defective from having insufficient insulation. Further, when outer layers are formed on the external electrodes 106a and 106b by means of plating, the plating grows at that portion, whereby the coil becomes defective.

SUMMARY A laminated coil in an exemplary embodiment of the present disclosure overcomes the aforementioned problems of the related art, and includes: a laminate including substantially rectangular insulating layers and coil patterns that are alternately laminated and unified; through holes formed to respectively extend through the insulating layers; a coil formed inside the laminate and including the coil patterns connected to each other via the through holes; a pair of external electrodes formed on both ends of the laminate and respectively connected to both ends of the coil; and an insulating film formed on an outer peripheral surface of the laminate. In the laminated coil in which at least one of the through holes is partially exposed in the surface of the laminate, the through hole exposed in the surface of the laminate is formed in contact with one side of an outer edge of the insulating layer but out of contact with the other sides other than the one side. In other words, the through hole partially exposed in the surface of the laminate is formed in a portion of the insulating layer other than corners where the thickness of the insulating film is small. As a result, in the laminated coil of the present invention, the through hole is not exposed from the insulating film to the outside.

Preferably, the through hole is formed in contact with a portion of the one side of the outer edge of the insulating layer, wherein the portion includes a center of the one side and falls within a range of about 1/3 of the one side. This is because the thickness of the insulating film is sufficiently large at the portion of the one side of the outer edge of the insulating layer which includes the center of the one side and falls within a range of about 1/3 of the one side, and thus the through hole can assuredly be prevented from being exposed from the insulating film to the outside.

Further, more preferably, the through hole is formed in contact with the center of the one side of the outer edge of the insulating layer. This is because the thickness of the insulating film is at a maximum at the center of the one side of the outer edge of the insulating layer, and thus the through hole can more assuredly be prevented from being exposed from the insulating film to the outside.

Due to the configuration described above, the laminated coil of an exemplary embodiment of the present disclosure can increase the coil patterns in size without increasing the entire shape in size, to improve the coil characteristics. In addition, since none of the through holes are exposed from the insulating film to the outside, the laminated coil does not become a defective due to insulation failure.

When the coil patterns are increased in size, the following coil characteristics are improved. In a magnetic-core type laminated coil, when the inner and outer diameters of the coil patterns are increased while the widths of the coil patterns are kept the same, the direct current superposition characteristics of the coil are improved. In an air-core type laminated coil, when the inner and outer diameters of the coil patterns are increased while the widths of the coil patterns are kept the same, the Q value of the coil can be increased. In each of the magnetic-core type and air-core type laminated coils, when the widths of the coil patterns are increased (the outer diameters are increased) while the inner diameters of the coil patterns are kept the same, the direct current resistances of the coil patterns can be decreased and the Q value of the coil can be increased.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view of a laminated coil according to an embodiment.

FIG. 2 is a cross-sectional view of the laminated coil shown in FIG. 1, showing a portion along a broken line X-X in FIG. 1.

FIG. 3 is an exploded perspective view of the laminated coil shown in FIG. 1, wherein external electrodes and an insulating film are omitted.

FIG. 4A is a cross-sectional view of a laminated coil according to a modified embodiment.

FIG. 4B is a cross-sectional view of a laminated coil according to still another modified embodiment.

FIG. 5 is a perspective view of an existing laminated coil.

FIG. 6 is a cross-sectional view of the laminated coil shown in FIG. 5, showing a portion along a broken line X-X in FIG. 5.

FIG. 7 is a cross-sectional view of the laminated coil shown in FIG. 5, showing a portion along a broken line Y-Y in FIG. 5.

FIG. 8 is an exploded perspective view of the laminated coil shown in FIG. 5, wherein external electrodes and an insulating film are omitted.

### DETAILED DESCRIPTION

Hereinafter, exemplary embodiments for implementing the laminated coil of the present disclosure will be described with reference to the drawings.

### Exemplary Embodiment

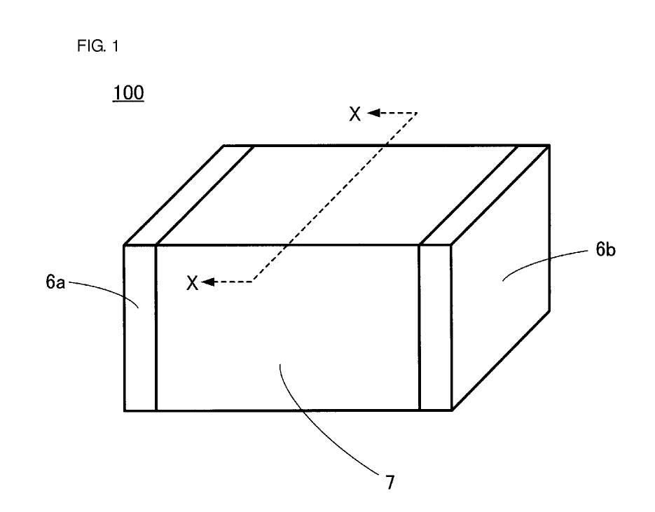

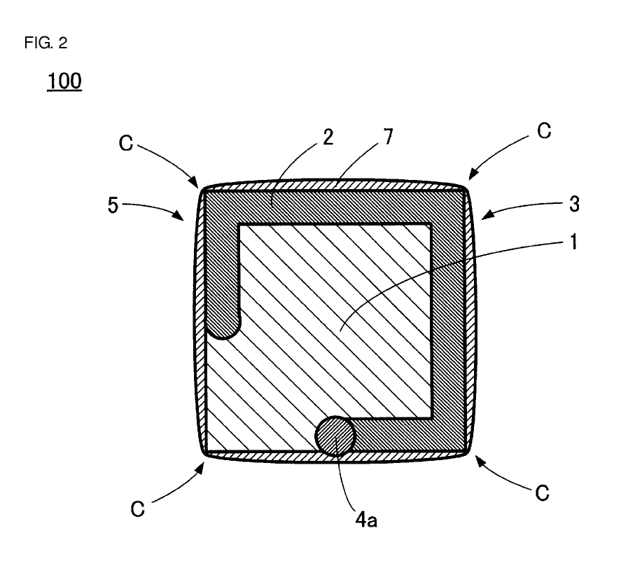

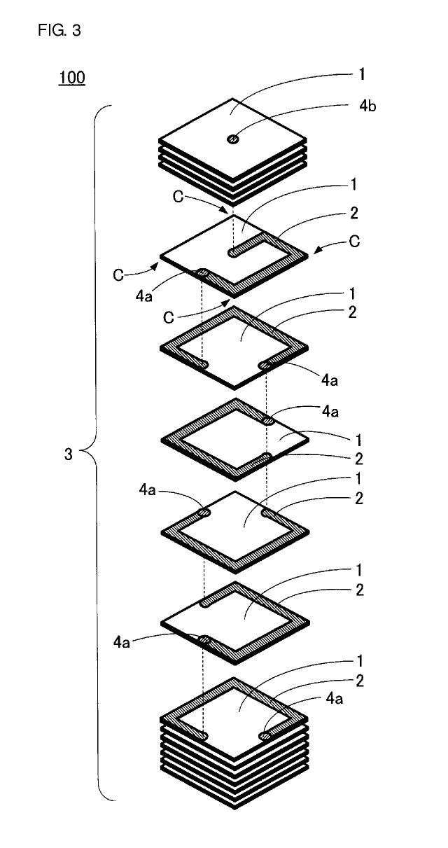

FIGS. 1 to 3 show a laminated coil 100 according to an exemplary embodiment of the present disclosure. FIG. 1 is a perspective view, FIG. 2 is a cross-sectional view of a portion along a broken line X-X in FIG. 1, and FIG. 3 is an exploded perspective view. In FIG. 3, external electrodes 6a and 6b and an insulating film 7 are omitted.

As shown in FIGS. 1 to 3, in the laminated coil 100, substantially rectangular insulating layers 1 each having four corners C and coil patterns 2 are alternately laminated and unified to form a laminate 3. The size of the laminate 3 may be, for example, about 0.6 mm long, about 1.0 mm wide, and about 1.9 mm thick.

For the insulating layers 1, for example, a magnetic material such as ferrite or a nonmagnetic material such as dielectric ceramics can be used. When a magnetic material is used for the insulating layers 1, the laminated coil 100 is a magnetic-core type. When a nonmagnetic material is used for the insulating layers 1, the laminated coil 100 is an air-core type. The size of each insulating layer 1 may be, for example, about 0.6 mm long, about 1.0 mm wide, and about 40 μm thick.

For the coil patterns 2, for example, silver, palladium, copper, gold, silver-palladium, or the like can be used. The shapes and lengths of the coil patterns 2 depend on the laminated positions. The magnitudes of the widths of the coil patterns 2 may be about 100 μm.

The outer edges of the coil patterns 2 are in contact with the outer edges of the insulating layers 1. In other words, gaps between the outer edges of the coil patterns 2 and the outer edges of the insulating layers 1 are zero.

Then, the coil patterns 2 are connected to each other via through holes 4a that are formed to extend through the insulating layers 1, respectively, to form a coil 5 within the laminate 3. It should be noted that near both ends of the laminate 3, no coil patterns 102 are laminated, and a plurality of insulating layers 1 having through holes 4b for drawing the coil 5 to the outside are laminated. The through holes 4a and 4b are substantially cylindrical in the embodiment.

Each through hole 4a is formed in a portion of the insulating layer 1 other than the four corners C and in contact with only one side of the outer edge of the insulating layer 1. For example, in the drawing of FIG. 2, the through hole 4a is in contact with only the side located on the lower side of the insulating layer, and is out of contact with the side located on the left side, the side located on the upper side, and the side located on the right side. It should be noted that due to the difference of contraction at firing, the through hole 4a is often formed to project from the insulating layer 1 to the outside.

Then, at the both ends of the laminate 3, a pair of the external electrodes 6a and 6b are formed. The external electrode 6a is connected to one end of the coil 5, and the external electrode 6b is connected to the other end of the coil 5. For the external electrodes 6a and 6b, for example, copper, silver, nickel, or the like can be used. In addition, each of the external electrodes 6a and 6b is not limited to a single layer, and may be formed from different materials into a multilayer electrode.

Further, on the outer peripheral surface of the laminate 3, an insulating film 7 made of an insulating resin such as an epoxy resin is formed. Although depending on the size of the laminate 3, the thickness of the insulating film 7 is, for example, about 50 to 100 μm near the center of the outer peripheral surface of the laminate 3. However, the thickness of the insulating film 7 is small at the ridge portions of the laminate 3, namely, near the four corners C of the insulating layers 1, similarly to the above-discussed related art.

However, in the embodiment, each through hole 4a is not formed at any corner C of the insulating layer 1 where the thickness of the insulating film 7 is small, but is formed in contact with the center of one side of the insulating layer 1 where the thickness of the insulating film 7 is maximum. Thus, each through hole 4a is not exposed to the outside to decrease the insulating properties of the laminated coil 100.

The laminated coil 100 having such a structure according to the embodiment of the present invention is manufactured, for example, by the following method.

First, in order to manufacture a large number of laminated coils 100 in batch, a plurality of mother green sheets (not shown) from which the insulating layers 1 are formed are prepared. The mother green sheets are obtained by mixing a magnetic material or a nonmagnetic material with a binder or the like to create a slurry material and forming the slurry material into sheets with a doctor blade or the like.

Next, in each mother green sheet, through holes 4a and 4b for a plurality of laminated coils 100 are formed, and coil patterns 2 are formed. The through holes 4a and 4b are formed, for example, by embedding a conductive paste in holes that are previously formed in the mother green sheet. The coil patterns 2 are formed, for example, by screen-printing a conductive paste on a surface of the mother green sheet into a predetermined shape.

Next, the mother green sheets in which the predetermined through holes 4a and 4b and coil patterns 2 are formed are laminated in a predetermined order and compressed to form a laminate block (not shown).

Next, the laminate block is cut into a plurality of unfired laminates 3. After the cutting, the unfired laminates 3 may be subjected to barrel polishing to remove burrs that occur at the cutting.

Next, a plurality of the unfired laminates 3 are fired at a predetermined profile to obtain a plurality of laminates 3.

It should be noted that the process order may not be the order in which a laminate block is formed and cut into a plurality of unfired laminates 3, and these laminates 3 are fired as described above, and may be an order in which a laminate block is formed and fired, and the fired laminate block is cut into laminates 3.

Next, external electrodes 6a and 6b are formed on both ends of each laminate 3. The external electrodes 6a and 6b are formed, for example, by immersing the ends of each laminate 103 in a conductive paste to apply the conductive paste thereto, and performing baking.

Next, an insulating film 7 is formed on the outer peripheral surface of each laminate 3. The insulating film 7 is formed by applying, for example, a thermoplastic epoxy resin to the outer peripheral surface of the laminate 3 by means of immersion (dipping) or printing, and heating the resin to cure the resin.

Then, further, on the external electrodes 6a and 6b, outer layers may be formed by means of plating or the like.

It should be noted that formation of the external electrodes 6a and 6b and formation of the insulating film 7 on each laminate 3 may be interchanged in their order. In addition, when outer layers are formed on the external electrodes 6a and 6b by means of plating or the like, the outer layers may be formed prior to forming the insulating film 7.

The laminated coil 100 according to the exemplary embodiment of the present disclosure and the example of its manufacturing method have been described above. However, the present disclosure is not limited to these contents, and various modifications can be made in accordance with the concepts of the disclosure.

For example, the shapes, the sizes, the number of the insulating layers 1 and the coil patterns 2 are arbitrary and are not limited to the above contents. In addition, the shapes and the sizes of the through holes 4a and 4b are also arbitrary and are not limited to the above contents.

Further, the ridge portions of the laminate 3 (the corners C of the insulating layers 1) may be subjected to barrel polishing to be rounded.

### Modified embodiments

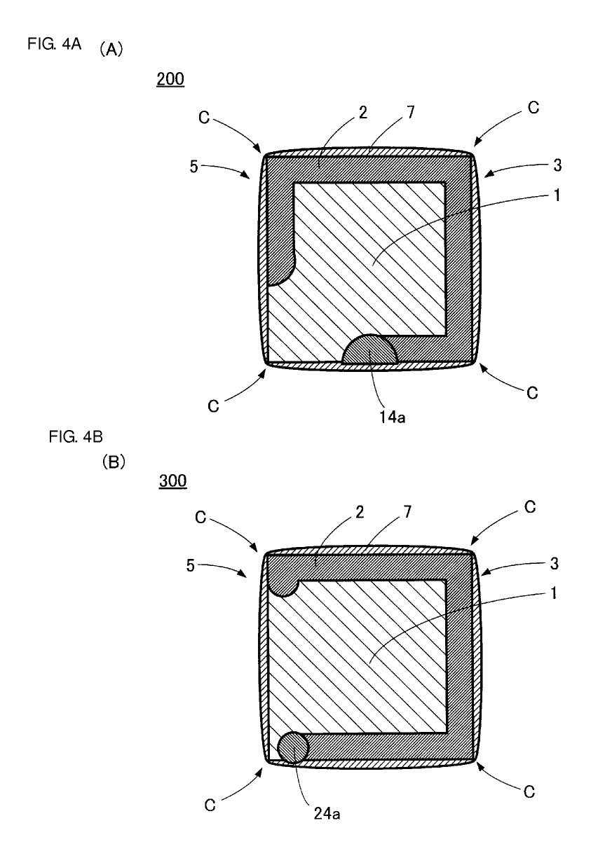

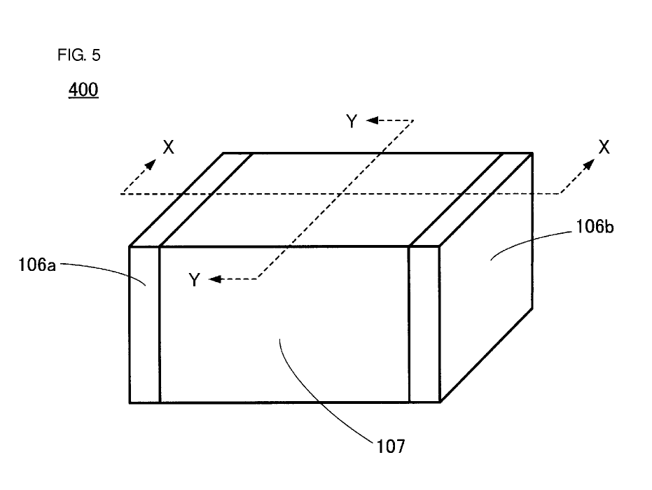

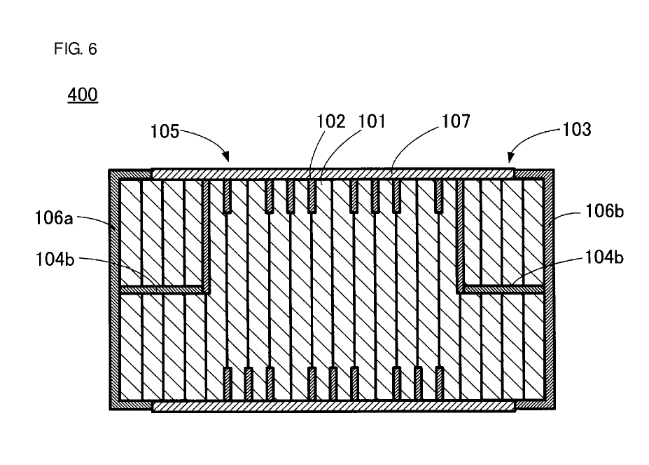

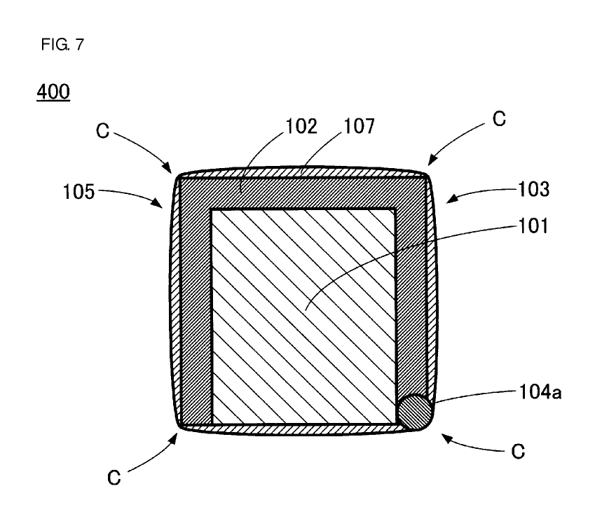

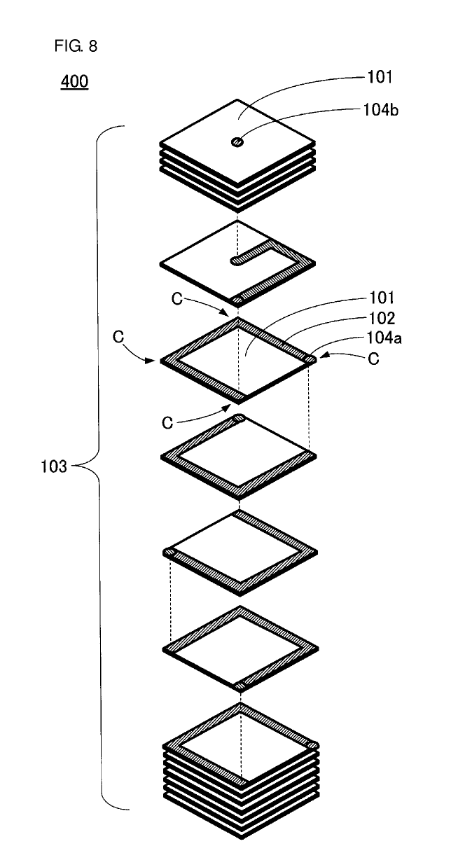

FIG. 4A shows a laminated coil 200 according to a modified embodiment of the present invention. FIG. 4A is a cross-sectional view of the laminated coil 200.

In the laminated coil 200, the shapes of the through holes 4a in the laminated coil 100 according to the embodiment described above are changed. It should be noted that the other portions are the same as those in the laminated coil 100.

In the laminated coil 200, each through hole 14a is not cylindrical but has a shape of one of two halves of a substantially cylindrical shape that has been cut into two along a plane in the longitudinal direction.

In other words, in the laminated coil 200, substantially cylindrical through holes (not shown) having larger diameters are formed at boundaries of adjacent insulating layers 1 in mother green sheets for manufacturing a large number of laminated coils 200 in batch, from which a large number of insulating layers are formed. These mother green sheets are laminated and compressed to form a laminate block (not shown). When the laminate block is cut into a plurality of unfired laminates 3, each of the substantially cylindrical through holes having larger diameters is cut into two to obtain the through holes 14a.

As described above, the shapes of the through holes are arbitrary, and the through holes are not limited to the substantially cylindrical through holes 4a as in the laminated coil 100 according to the embodiment described above. For example, as in the laminated coil 200 according to the modified embodiment, each through hole may be the through hole 14a having a shape of one of two halves of a substantially cylindrical shape that has been cut into two along a plane in the longitudinal direction. Alternatively, each through hole may have a substantially rectangular cylindrical shape.

Next, FIG. 4B shows a laminated coil 300 according to another modified embodiment of the present invention. FIG. 4B is a cross-sectional view of the laminated coil 300.

In the laminated coil 300, the positions in which the through holes 4a in the laminated coil 100 according to the embodiment described above are formed are changed.

In the laminated coil 300, each through hole 24a is formed near the corner C of the insulating layer 1. It should be noted that each through hole 24a is near the corner C of the insulating layer 1 but does not reach the corner C. In other words, in the drawing of FIG. 4B, the through hole 24a is in contact with the side of the insulating layer 1 located on the lower side but is out of contact with the side located on the left side. In addition, with the change of the position in which each through hole 24a is formed, the positions where the coil patterns 2 are formed are also changed. However, the lengths of the coil patterns 2 are not changed.

As described above, each through hole does not necessarily need to be formed in contact with one side of the insulating layer 1, and may be formed in contact with any one of the sides of the insulating layer 1 as long as it is formed in a portion other than the corners C of the insulating layer 1. However, when the thickness of the insulating film 7 is taken into consideration, in order to prevent each through hole from being exposed to the outside, each through hole is preferably formed in contact with a portion of one side of the insulating layer 1 which includes the center of the one side and falls within a range of about 1/3 of the side, and more preferably formed in contact with the center of one side of the insulating layer 1.

While preferred embodiments of the disclosure have been described above, it is to be understood that variations and modifications will be apparent to those skilled in the art without departing from the scope and spirit of the disclosure.

What is claimed is:

1. A laminated coil comprising:
a laminate having an outer peripheral surface, the laminate including substantially rectangular insulating layers,
each insulating layer including four sides forming an outer edge of the insulating layer,
each insulating layer including a coil pattern, and the insulating layers being alternately laminated and unified;
through holes formed to respectively extend through each of the insulating layers;
a coil positioned inside the laminate and formed by the coil pattern on each of the insulating layers connected to each other via the respective through holes;
a pair of external electrodes formed on both ends of the laminate, each external electrode being respectively connected to each end of the coil; and
an insulating film formed on the outer peripheral surface of the laminate, wherein
at least one of the through holes on each insulating layer is partially exposed in the surface of the laminate, the through hole exposed in the surface of the laminate is formed in contact with one side of the outer edge of the insulating layer but not in contact with the other three sides.

2. The laminated coil according to claim 1, wherein the coil pattern whose end is connected to the through hole exposed in the surface of the laminate is formed such that an outer edge thereof is at least partially in contact with the outer edge of the insulating layer.

3. The laminated coil according to claim 1, wherein the through hole exposed in the surface of the laminate is formed in contact with a portion of the one side of the outer edge of the insulating layer, wherein the portion includes a center of the one side.

4. The laminated coil according to claim 3, wherein the portion falls within a range of about 1/3 of the one side.

5. The laminated coil according to claim 2, wherein the through hole exposed in the surface of the laminate is formed in contact with a portion of the one side of the outer edge of the insulating layer, wherein the portion being positioned at a center of the one side or falls within a range of about 1/3 of the one side.

6. The laminated coil according to claim 3, wherein the through hole exposed in the surface of the laminate is formed in contact with the center of the one side of the outer edge of the insulating layer.

7. The laminated coil according to claim 1, wherein the insulating film is made of an insulating resin.

8. The laminated coil according to claim 2, wherein the insulating film is made of an insulating resin.

9. The laminated coil according to claim 3, wherein the insulating film is made of an insulating resin.

10. The laminated coil according to claim 4, wherein the insulating film is made of an insulating resin.

11. The laminated coil according to claim 1, wherein the through hole exposed in the surface of the laminate is fully coated with the insulating film so as not to be exposed to the outside.

12. The laminated coil according to claim 2, wherein the through hole exposed in the surface of the laminate is fully coated with the insulating film so as not to be exposed to the outside.

13. The laminated coil according to claim 3, wherein the through hole exposed in the surface of the laminate is fully coated with the insulating film so as not to be exposed to the outside.

14. The laminated coil according to claim 4, wherein the through hole exposed in the surface of the laminate is fully coated with the insulating film so as not to be exposed to the outside.

15. The laminated coil according to claim 5, wherein the through hole exposed in the surface of the laminate is fully coated with the insulating film so as not to be exposed to the outside.

16. The laminated coil according to claim 6, wherein the through hole exposed in the surface of the laminate is fully coated with the insulating film so as not to be exposed to the outside.
